(19) United States
(12) Patent Application Publication
(10) Pub. No.: US 2020/0175087 A1
(43) Pub. Date: Jun. 4, 2020

(54) COMMENT INFORMATION DISPLAYING METHOD, DEVICE, ELECTRONIC DEVICE, AND COMPUTER READABLE MEDIUM

(71) Applicant: ALIBABA GROUP HOLDING LIMITED, GRAND CAYMAN (KY)

(72) Inventor: Liansheng SUN, HANGZHOU (CN)

(21) Appl. No.: 16/700,292

(22) Filed: Dec. 2, 2019

(30) Foreign Application Priority Data
Dec. 3, 2018 (CN) 201811466742.8

(51) Int. Cl. G06F 16/9538; H04L 12/58; G06F 16/958

(52) U.S. Cl. CPC G06F 16/9538; G06F 16/986; H04L 51/046

(57) ABSTRACT

Methods, systems, and apparatus, including computer programs encoded on computer storage media, for displaying comment information are provided. One of the methods includes: receiving search result information that is in response to a search request, wherein the search result information comprises at least one piece of comment information associated with search information carried in the search request; determining, based on the search result information, comment integration information after a portion or all of the comment information is integrated; and displaying the comment integration information.

### CROSS REFERENCE TO RELATED APPLICATION

The present application is based on and claims priority to Chinese Patent Application No. 201811466742.8, filed on Dec. 3, 2018, the entire contents of which are incorporated herein by reference in the entirety.

### TECHNICAL FIELD

Embodiments of the present application relate to the field of Internet technologies, and in particular, to comment information displaying method, and device, electronic device, and computer readable medium.

### BACKGROUND

When a user searches for certain information using a search engine, the user may want to see comment information by a corresponding network user with respect to an event or object corresponding to current searched related information. However, most of the comment information is scattered at the end of a related document in a current search result page of the search engine, that is, scattered in a comment area of the related document in the current search result page. To view the comment information of events or objects corresponding to certain information, a user needs to separately view comment information in the comment area of each related document in a current search result page of a search engine, causing great inconvenience to the user. In addition, the user has to spend a lot of time to view the comment information.

### SUMMARY

Comment information displaying method, and device, electronic device, and computer readable medium are disclosed, to address an issue in existing technologies as how to help a user view comment information related to search information.

According to a first aspect of the embodiments, a method for displaying comment information is provided. The method includes: receiving search result information that is in response to a search request, where the search result information comprises at least one piece of comment information associated with search information carried in the search request; determining, based on the search result information, comment integration information after a portion or all of the comment information is integrated; and displaying the comment integration information.

According to a second aspect of the embodiments, a method for displaying comment information is provided. The method includes: receiving a search request from a terminal device; obtaining at least one piece of comment information associated with search information carried in the search request, and integrating the obtained at least one piece of comment information; and transmitting the integrated comment information to the terminal device.

According to a third aspect of the embodiments, a device for displaying comment information is provided. The device includes: a first receiving module configured to receive search result information that is in response to a search request, where the search result information comprises at least one piece of comment information associated with search information carried in the search request; a first determining module configured to determine, based on the search result information, comment integration information after a portion or all of the comment information is integrated, and a displaying module configured to display the comment integration information.

According to a fourth aspect of the embodiments, a device for displaying comment information is provided. The device includes: a third receiving module configured to receive a search request from a terminal device; and an integrating module configured to: obtain at least one piece of comment information associated with search information carried in the search request, and integrate the obtained at least one piece of comment information; and a transmitting module configured to transmit the integrated comment information to the terminal device.

According to a fifth aspect of the embodiments, an electronic device is provided, including: one or more processors; a computer readable medium configured to store one or more programs, when the one or more programs are executed by the one or more processors, the one or more processors implementing the method for displaying comment information as described in the foregoing first aspect or second aspect of the embodiments.

According to a sixth aspect of the embodiments, a computer readable medium is provided, a computer program being stored thereon, when the program is executed, the program implementing the method for displaying comment information as described in the foregoing first aspect or second aspect of the embodiments.

According to a seventh aspect, a non-transitory computer-readable storage medium for displaying comment information is configured with instructions executable by one or more processors to cause the one or more processors to perform operations comprising: receiving search result information that is in response to a search request, wherein the search result information comprises at least one piece of comment information associated with search information carried in the search request; determining, based on the search result information, comment integration information after a portion or all of the comment information is integrated; and displaying the comment integration information.

According to an eighth aspect, a system for displaying comment information comprises one or more processors and one or more non-transitory computer-readable memories coupled to the one or more processors and configured with instructions executable by the one or more processors to cause the system to perform operations comprising: receiving search result information that is in response to a search request, wherein the search result information comprises at least one piece of comment information associated with search information carried in the search request; determining, based on the search result information, comment integration information after a portion or all of the comment information is integrated; and displaying the comment integration information.

According to a ninth aspect, a non-transitory computer-readable storage medium for displaying comment information is configured with instructions executable by one or more processors to cause the one or more processors to perform operations comprising: receiving a search request from a terminal device; obtaining at least one piece of comment information associated with search information carried in the search request, and integrating the obtained at least one piece of comment information; and transmitting the integrated comment information to the terminal device.

According to a tenth aspect, a system for displaying comment information comprises one or more processors and one or more non-transitory computer-readable memories coupled to the one or more processors and configured with instructions executable by the one or more processors to cause the system to perform operations comprising: receiving a search request from a terminal device; obtaining at least one piece of comment information associated with search information carried in the search request, and integrating the obtained at least one piece of comment information; and transmitting the integrated comment information to the terminal device.

In the technical solutions provided in the embodiments of the present specification, the search result information that is in response to the search request is received, where the search result information comprises the at least one piece of comment information associated with the search information carried in the search request; the comment integration information after a portion or all of the comment information is integrated is determined based on the search result information; and then the comment integration information is displayed. The comment information associated with the search information input by the user can be integrated, helping the user to view the comment information associated with the search information, thereby reducing the time and cost spent by the user to view the comment information associated with the search information.

### BRIEF DESCRIPTION OF THE DRAWINGS

FIG. 1 is a flowchart of steps of a method for displaying comment information according to some embodiments;

FIG. 2 is a flowchart of steps of a method for displaying comment information according to some embodiments;

FIG. 3 is a flowchart of steps of a method for displaying comment information according to some embodiments;

FIG. 4 is a schematic diagram of an interface for displaying comment information according to some embodiments;

FIG. 5 is a schematic flowchart of a method for displaying comment information according to some embodiments;

FIG. 6 is a schematic structural diagram of a device for displaying comment information according to some embodiments;

FIG. 7 is a schematic structural diagram of a device for displaying comment information according to some embodiments;

FIG. 8 is a schematic structural diagram of a device for displaying comment information according to some embodiments;

FIG. 9 is a schematic structural diagram of a device for displaying comment information according to some embodiments;

FIG. 10 is a schematic structural diagram of a device for displaying comment information according to some embodiments;

FIG. 11 is a schematic structural diagram of an electronic device according to some embodiments; and

FIG. 12 shows a hardware structure of an electronic device according to some embodiments.

### DETAILED DESCRIPTION

The present specification is described in detail in the following with reference to the accompanying drawings by using embodiments. The embodiments in the present specification or the features in the embodiments may be combined together.

In existing technologies, most of comment information is scattered in a comment area of a related document in a current search result page of a search engine. When viewing comment information, a user needs to separately view comment information in a comment area of each related document in a current search result page of a search engine, causing great inconvenience to the user. In addition, the user spends a lot of time to view the comment information.

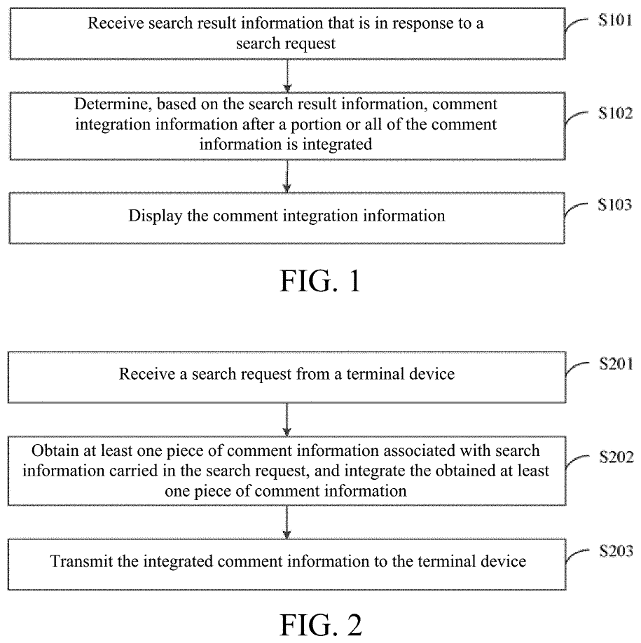

Referring to FIG. 1, a flowchart of steps of a method for displaying comment information according to some embodiments is shown.

In some embodiments, the method for displaying comment information is described from a perspective of a terminal device. For example, the method for displaying comment information includes the following steps.

In step S101, search result information that is in response to a search request is received.

In some embodiments, a client of the terminal device receives the search result information that is sent by the server and that is in response to the search request. The client of the terminal device includes a front end of a search engine, a WeChat (a multi-purpose messaging, social media, and mobile payment Application) client, a Taobao (an e-commerce platform) client, a Zhihu (a question-and-answer online media where all kinds of questions are created, answered, edited, and organized by the community of its users) client, and a UC browser (a web browser), etc. and the search result information comprises at least one piece of comment information associated with search information carried in the search request. The foregoing description is merely an example, and no limitation is imposed.

In some optional embodiments, before the receiving search result information that is in response to a search request, the method further includes: sending the search request to a server in response to an operation on a comment displaying control in a page, wherein the search result information is sent by the server. Therefore, the comment displaying control configured in the page can help a user view the comment information related to the search information. The foregoing description is merely an example, and no limitation is imposed.

In one example, the front end of the search engine receives an operation of a user on a comment displaying control in a current search result page of a search engine, the operation being used to instruct to display comment information related to the search information. The front end of the search engine sends the current search result page to the server in response to the operation of the user on the comment displaying control in the current search result page. The search request comprises the search information input by the user through the front end of the search engine. Therefore, the comment displaying control disposed in the current search result page can help the user to view the comment information related to the search information. The foregoing description is merely an example, and no limitation is imposed.

In one example, the operation may include, but is not limited to, a tap operation, a long press operation, etc. The operation is used to instruct to display the comment information related to the search information input by the user using the front end of the search engine. The comment displaying control may be a button that displays “View comment,” and the comment displaying control may be at any location on the current search result page of the search engine, for example, may be located below a search box in the current search result page, or may be located on a right side of the search box in the current search result page. The comment information includes at least one of the following: identification information, a comment content, and a commenting time of a commenting user. For example, the identification information of the commenting user may include, but is not limited to, an account number, a nickname of the user, etc. The foregoing description is merely an example, and no limitation is imposed.

In step S102, comment integration information after a portion or all of the comment information is integrated is determined based on the search result information.

In some optional embodiments, when the comment information carried in the search result information is being integrated on a terminal device side, the determining, based on the search result information, comment integration information after a portion or all of the comment information is integrated includes: integrating, based on a preset integrating template, the portion or all of the comment information carried in the search result information to obtain the comment integration information. The preset integrating template may be configured by a person skilled in the art according to an actual requirement, and no limitation is imposed. Therefore, the comment information that is input by the user and that is associated with the search information can be integrated to help the user to view the comment information associated with the search information, thereby saving time and cost for the user to view the comment information associated with the search information. Any implementation of determining, based on the search result information, the comment integration information after the portion or all of the comment information is integrated may be applied to the present application, and no limitation is imposed.

In some optional embodiments, when the comment information carried in the search result information is being integrated on a server side, the determining, based on the search result information, comment integration information after a portion or all of the comment information is integrated includes: obtaining, from the search result information, the comment integration information after the portion or all of the comment information is integrated. Therefore, the comment information that is input by the user and that is associated with the search information can be integrated to help the user to view the comment information associated with the search information, thereby saving time and cost for the user to view the comment information associated with the search information. Any implementation of determining, based on the search result information, the comment integration information after the portion or all of the comment information is integrated may be applied to the present application, and no limitation is imposed.

In step S103, the comment integration information is displayed.

In some optional embodiments, during the displaying of the comment integration information, the comment integration information is displayed in a barrage form, which helps the user to quickly view the comment integration information related to the search information. Any implementation of displaying the comment integration information may be applied to the present application, and no limitation is imposed.

In one example, during the displaying of the comment integration information in barrage form, the comment integration is displayed in a barrage form in a comment sub-page of the current search result page of the search engine, which helps the user to quickly view the comment information related to the search information. Any implementation of displaying the comment integration information in a barrage form may be applied to the present application, and no limitation is imposed.

In some optional embodiments, during the displaying of the comment integration information, the comment integration information is displayed using a floating window or a sliding window, which helps the user to view the comment integration information related to the search information according to the user's own need. Any implementation of displaying the comment integration information may be applied to the present application, and no limitation is imposed.

In one example, during the displaying of the comment integration information using a floating window or a sliding window, the comment integration information is displayed using a floating window or a sliding window in the comment sub-page of the current search result page of the search engine, which helps the user to view the comment integration information related to the search information according to the user's own need. Any implementation of displaying the comment integration information using a floating window or a sliding window may be applied to the present application, and no limitation is imposed.

In some optional embodiments, after the displaying the comment integration information, the method further includes: receiving a publishing operation that is input by a user and that is based on the comment integration information; and publishing the comment information of the user based on the publishing operation, which helps the user to publish the comment information without registering an account, thereby avoiding significant waste of time and effort by the user. The foregoing description is merely an example, and no limitation is imposed.

In one example, the front end of the search engine receives the publishing operation input by the user through the comment sub-page, and publishes the comment information of the user based on the publishing operation. The foregoing description is merely an example, and no limitation is imposed.

In the method for displaying comment information, the search result information that is in response to the search request is received, where the search result information comprises at least one piece of comment information associated with search information carried in the search request; the comment integration information after a portion or all of the comment information is integrated is determined based on the search result information; and then the comment integration information is displayed. The comment information associated with the search information input by the user can be integrated, helping the user to view the comment information associated with the search information, thereby reducing the time and cost spent by the user to view the comment information associated with the search information.

The method for displaying comment information may be performed by any suitable device having a data processing capability, including but not limited to: a camera, a terminal, a mobile terminal, a PC, a server, an in-vehicle device, an entertainment device, an advertising device, and a personal digital assistant (PDA), a tablet computer, a notebook computer, a handheld game console, smart glasses, a smart watch, a wearable device, a virtual display device, or a display enhancement device (such as Google Glass, Oculus Rift, Hololens, Gear VR), etc.

Referring to FIG. 2, a flowchart of steps of a method for displaying comment information according to some embodiments is shown.

In some embodiments, the method for displaying comment information is described from a perspective of a server. For example, the method for displaying comment information includes the following steps.

In step S201, a search request from a terminal device is received.

In some embodiments, the server receives the search request sent by a client of the terminal device, the search request carrying search information input by a user. The client of the terminal device includes a front end of the search engine, a WeChat client, a Taobao client, a Zhihu client, and a UC browser, etc. The foregoing description is merely an example, and no limitation is imposed.

In step S202, at least one piece of comment information associated with the search information carried in the search request is obtained, and the obtained at least one piece of comment information is integrated.

In some optional embodiments, before the obtaining at least one piece of comment information associated with search information carried in the search request, the method further includes: if a crawled webpage document comprises corresponding comment information, extracting the comment information in the webpage document; and establishing an index relationship between a title of the webpage document and the comment information in the webpage document. Therefore, the index relationship between the title of the webpage document and the comment information in the webpage document can be established, so that it is convenient to retrieve, from the comment information in the webpage document, the comment information related to the search information input by the user. The foregoing description is merely an example, and no limitation is imposed.

In one example, the server crawls a webpage document from a specific website of a network through a web crawler. If the server recognizes that the crawled webpage document comprises corresponding comment information, the server extracts comment information in the webpage document. The comment information includes at least one of identification information, a comment content, and a commenting time. Then the server establishes an index relationship between a title of the webpage document and the comment information in the webpage document. The foregoing description is merely an example, and no limitation is imposed.

In some optional embodiments, during the obtaining of the at least one piece of comment information associated with the search information carried in the search request, in response to determining that the search information matches the title of the webpage document, it is determined based on the index relationship that the comment information in the webpage document is the comment information associated with the search information carried in the search request. Therefore, the comment information related to the search information can be accurately determined. Any implementation of obtaining the at least one piece of comment information associated with the search information carried in the search request may be applied to the present application, and no limitation is imposed.

In some optional embodiments, before the determining, based on the index relationship, that the comment information in the webpage document is the comment information associated with the search information carried in the search request, the method further includes: segmenting the title of the webpage document to determine segmented words of the title of the webpage document; segmenting a content of the search information to determine segmented words of the search information; and if the segmented words of the title of the webpage document include the segmented words of the search information, determining that the search information matches the title of the webpage document. Therefore, whether the search information matches the title of the webpage document can be accurately determined. The foregoing description is merely an example, and no limitation is imposed.

In some optional embodiments, after the segmenting a content of the search information to determine segmented words of the search information, the method further includes: performing stop word filtering on the segmented words of the search information to obtain filtered segmented words of the search information; and if the segmented words of the title of the webpage document include the filtered segmented words of the search information, determining that the search information matches the title of the webpage document. Therefore, whether the search information matches the title of the webpage document can be more accurately determined. The foregoing description is merely an example, and no limitation is imposed.

In one example, stop word filtering is filtering out a meaningless word in the segmented words of the search information, for example an auxiliary word, a number, etc. In one embodiment, a stop word lexicon may be pre-established for matching, and a stop word is filtered. Stop word filtering may further include removing a word that has little to do with the meaning of the search information such as polite expression (for example, excuse me, etc.), auxiliary words (for example, be of, what, how, ah, etc.), etc. The foregoing descriptions are merely examples, and no limitation is imposed.

In some optional embodiments, before the determining, based on the index relationship, that the comment information in the webpage document is the comment information associated with the search information carried in the search request, the method further includes: segmenting the title of the webpage document to determine the segmented words of the title of the webpage document; generating, based on the segmented words of the title of the webpage document, a vector representing the title of the webpage document; segmenting the content of the search information to determine the segmented words of the search information; generating, based on the segmented words of the search information, a vector representing the search information; determining a similarity between the title of the webpage document and the search information based on the vector representing the title of the webpage document and the vector representing the search information; and if the similarity between the title of the webpage document and the search information is greater than or equal to a preset similarity threshold, determining that the title of the webpage document matches the search information. The preset similarity threshold may be configured by a person skilled in the art according to an actual requirement, and no limitation is imposed. Therefore, whether the search information matches the title of the webpage document can be accurately determined. The foregoing description is merely an example, and no limitation is imposed.

In some optional embodiments, after the obtaining at least one piece of comment information associated with search information carried in the search request, the method further includes: determining a similarity between the search information and the comment information, and ranking the comment information based on the similarity between the search information and the comment information, to determine a ranking result of the comment information; or ranking the comment information based on a number of messages that indicate a popular opinion and that are associated with the comment information, to determine a ranking result of the comment information; or ranking the comment information based on an amount of content of the comment information, to determine a ranking result of the comment information; or ranking the comment information based on a commenting time of the comment information, to determine a ranking result of the comment information; or determining a similarity between the search information and the title of the webpage document to which the comment information belongs, and ranking the comment information based on the similarity between the search information and the title of the webpage document to which the comment information belongs, to determine a ranking result of the comment information. Therefore, the comment information can be ranked according to ranking feature parameters of different dimensions (for example, the similarity between the search information and the comment information, the number of messages that indicate the popular opinion and that are associated with the comment information, the commenting time of the comment information, the amount of content of the comment information, the similarity between the search information and the title of the webpage document to which the comment information belongs), thereby improving accuracy of the ranking result of the comment information. The foregoing description is merely an example, and no limitation is imposed.

In one example, a greater similarity between the search information and the comment information indicates a higher ranking of the comment information, and a smaller the similarity between the search information and the comment information indicates a lower ranking of the comment information. The number of messages that indicate the popular opinion and that are associated with the comment information may include a number of times the comment information is liked by other network users, or a number of times the comment information is disliked by other network users, etc. When the number of messages that indicate the popular opinion and that are associated with the comment information may include the number of times the comment information is liked by other network users, a larger number of times that the comment information is liked by other network users indicates a higher ranking of the comment information. When the number of messages that indicate the popular opinion and that are associated with the comment information may include the number of times the comment information is viewed and commented by other network users, a smaller number of times the comment information is viewed and commented by other network users indicates a lower ranking of the comment information. The amount of content of the comment information may be represented using a number of Chinese characters or English words included in the content of the comment information. A larger amount of content of the comment information indicates a higher ranking of the comment information, and a smaller amount of content of the comment information indicates a lower ranking of the comment information. An earlier commenting time of the comment information indicates a higher ranking of the comment information, and a later commenting time of the comment information indicates a lower ranking of the comment information. A greater similarity between the search information and the title of the webpage document to which the comment information belongs indicates a higher ranking of the comment information, and a smaller similarity between the search information and the title of the webpage document to which the comment information belongs indicates a lower ranking of the comment information. The foregoing description is merely an example, and no limitation is imposed.

In some optional embodiments, during the determining of the similarity between the search information and the comment information, the content of the comment information is segmented to determine the segmented words of the comment information; and the first vector representing the comment information is generated based on the segmented words of the comment information; the content of the search information is segmented to determine the segmented words of the search information; and the second vector representing the comment information is generated based on the segmented words of the search information; and the similarity between the search information and the comment information is determined based on the first vector and the second vector. Therefore, the similarity between the search information and the comment information can be accurately determined. Any implementation of determining the similarity between the search information and the comment information may be applied to the present application, and no limitation is imposed.

In one example, during the generating of the first vector representing the comment information, the first vector representing the comment information may be generated based on the segmented words of the comment information using a semantic vector generating model. During the generating of the second vector representing the search information, the second vector representing the search information may be generated based on the segmented words of the search information using a semantic vector generating model. During the determining of the similarity between the search information and the comment information, a cosine similarity between the first vector and the second vector may be determined as the similarity between the search information and the comment information. The foregoing description is merely an example, and no limitation is imposed.

In some optional embodiments, during the determining of the similarity between the search information and the title of the webpage document to which the comment information belongs, the content of the search information is segmented, to determine the segmented words of the search information; the second vector representing the comment information is generated based on the segmented words of the search information; the title is segmented, to determine the segmented words of the title; a third vector representing the comment information is generated based on the segmented words of the title; and the similarity between the search information and the title of the webpage document to which the comment information belongs is determined based on the second vector and the third vector. Therefore, the similarity between the search information and the title of the webpage document to which the comment information belongs can be accurately determined. Any implementation of determining the similarity between the search information and the title of the webpage document to which the comment information belongs may be applied to the present application, and no limitation is imposed.

In one example, during the generating of the second vector representing the search information, the second vector representing the search information may be generated based on the segmented words of the search information using a semantic vector generating model. During the generating of the third vector representing the title, the third vector representing the title may be generated based on the segmented words of the title using a semantic vector generating model. During the determining of the similarity between the search information and the title of the webpage document to which the comment information belongs, a cosine similarity between the second vector and the third vector may be determined as the similarity between the search information and the title of the webpage document to which the comment information belongs. The foregoing description is merely an example, and no limitation is imposed.

In some optional embodiments, after the obtaining at least one piece of comment information associated with search information carried in the search request, the method further includes: ranking the comment information based on the similarity between the search information and the comment information, the number of messages that indicate the popular opinion and that are associated with the comment information, the commenting time of the comment information, the amount of content of the comment information, and the similarity between the search information and the title of the webpage document to which the comment information belongs, to determine the ranking result of the comment information. Therefore, a plurality of ranking feature parameters of different dimensions can be combined to rank the comment information, thereby further improving the accuracy of the ranking result of the comment information. The foregoing description is merely an example, and no limitation is imposed.

In one example, a combined ranking score of each piece of comment information may be determined according to the following formula 1:

S=w₁*f₁+w₂*f₂+w₃*f₃+w₄*f₄+w₅*f₅ Formula 1

S represents a combined ranking score of the comment information, f₁ represents the similarity between the search information and the comment information, and w₁ represents a weight value of the similarity between the search information and the comment information, f₂ represents the number of messages that indicate the popularopinion and that are associated with the comment information, and w₂ represents a weight value of the number of messages that indicate the popular opinion and that are associated with the comment information, f₃ represents the commenting time of the comment information, and w₃ represents a weight value of the commenting time of the comment information, f₄ represents the amount of content of the comment information, and w₄ represents a weight value of the amount of the content of the comment information, and f₅ represents the similarity between the search information and the title of the webpage document to which the comment information belongs, and w₅ represents a weight value of the similarity between the search information and the title of the webpage document to which the comment information belongs. After the combined ranking score of each piece of comment information is determined, the comment information may be ranked according to the combined ranking score of the comment information, to determine the ranking result of the comment information. The foregoing description is merely an example, and no limitation is imposed.

In some optional embodiments, during the integration of the obtained at least one piece of comment information, the obtained at least one piece of comment information is integrated based on the ranking result of the comment information. Therefore, comment information that is highly associated with the search information input by the user can be displayed preferentially. Any of implementation of integrating the obtained at least one piece of comment information may be applied to the present application, and no limitation is imposed.

In one example, the first N pieces of comment information are selected based on the ranking result of the comment information to be integrated, so that the front end of the search engine displays the N pieces of comment information in the current search result page. N may be configured by a person skilled in the art according to an actual requirement, and no limitation is imposed. The foregoing description is merely an example, and no limitation is imposed.

In step S203, the integrated comment information is transmitted to the terminal device.

In the method for displaying comment information, the search request sent by terminal device is received, and the at least one piece of comment information associated with the search information carried in the search request is obtained, and then the obtained at least one piece of comment information is integrated, and then the integrated comment information is transmitted to the terminal device. The comment information related to the search information input by the user can be integrated, helping the user to view the comment information related to the search information, thereby reducing the time and cost spent by the user to view the comment information related to the search information.

The method for displaying comment information may be performed by any suitable device having a data processing capability, including but not limited to: a camera, a terminal, a mobile terminal, a PC, a server, an in-vehicle device, an entertainment device, an advertising device, and a personal digital assistant (PDA), a tablet computer, a notebook computer, a handheld game console, smart glasses, a smart watch, a wearable device, a virtual displaying device, or a display enhancement device (such as Google Glass, Oculus Rift, Hololens, Gear VR), etc.

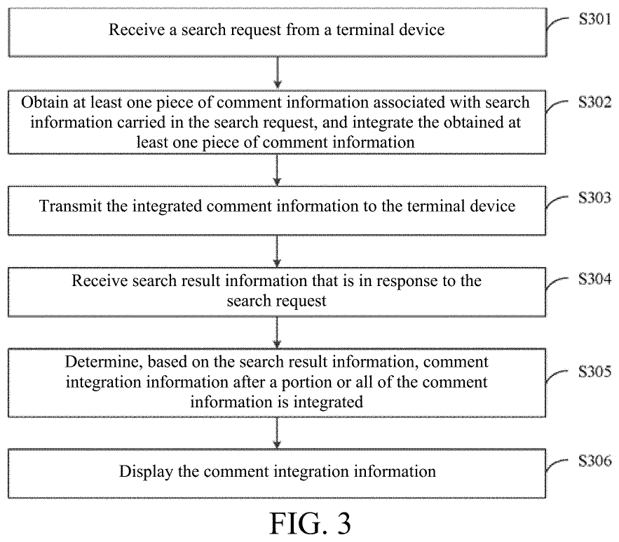

Referring to FIG. 3, a flowchart of steps of a method for displaying comment information according to some embodiments is shown.

In some embodiments, the method for displaying comment information is described from a perspective of interaction between a terminal device and a server. For example, the method for displaying comment information includes the following steps.

In step S301, a search request from a terminal device is received.

In one example, a front end of a search engine receives an operation of a user on a comment displaying control in a current search result page of a search engine, the operation being used to instruct to display comment information related to the search information. The front end of the search engine sends the current search result page to the server in response to the operation of the user on the comment displaying control in the current search result page. The search request comprises the search information input by the user through the front end of the search engine. Therefore, the comment displaying control disposed in the current search result page can help the user to view the comment information related to the search information. The foregoing description is merely an example, and no limitation is imposed.

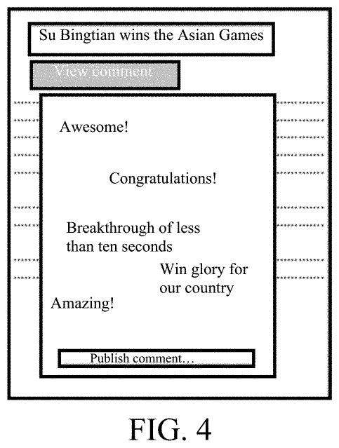

In one example, the comment displaying control may be a button displaying a “View comment,” and the comment displaying control may be at any location on the current search result page of the search engine, for example, may be located below a search box in the current search result page, which is shown in FIG. 4. The search information may be “Su Bingtian wins the Asian Games,” etc. The foregoing description is merely an example, and no limitation is imposed.

In step S302, at least one piece of comment information associated with search information carried in the search request is obtained, and the obtained at least one piece of the comment information is integrated.

Since step S302 is similar to the foregoing step S202, details are not described herein again.

In step S303, the integrated comment information is transmitted to the terminal device.

Since step S303 is similar to the foregoing step S203, details are not described herein again.

In step S304, search result information that is in response to the search request is received.

Since step S304 is similar to the foregoing step S101, details are not described herein again.

In step S305, comment integration information after a portion or all of the comment information is integrated is determined based on the search result information.

Since step S305 is similar to the foregoing step S102, details are not described herein again.

In step S306, the comment integration information is displayed.

In one example, as shown in FIG. 4, when a user inputs the search information “Su Bingtian wins the Asian Games” through a search box at the front end of the search engine, and the user taps the button “View comment” located below the search box at the front end of the search engine, a comment sub-page shown in FIG. 4 pops up in the current search result page of the front end of the search engine, and comment information, such as “Awesome,” “breakthrough of less than ten seconds,” etc. related to the search information “Su Bingtian wins the Asian Games” is displayed in the comment sub-page in a barrage form. In addition, the user can input the user's own comment information through a comment publishing box in the comment sub-page, to express the user's own opinion on the event “Su Bingtian wins the Asian Games”. The foregoing description is merely an example, and no limitation is imposed.

In one example, a comment displaying control is disposed in the current search result page of the front end of the search engine to collectively display the comment information related to the search information input by the user through the front end of the search engine, or a comment displaying control may be disposed in a page in which a video is played to collectively display comment information related to the video that is currently played, or a comment displaying control may be disposed in a page in which an electronic reading object is displayed to collectively display comment information related to the electronic reading object, or a comment displaying control may be disposed in a page in which a commodity is displayed to collectively display comment information related to the commodity, or a comment displaying control may be disposed in a page in which an image is displayed to collectively display comment information related to the image. The electronic reading object includes an electronic book, online electronic reading, electronic news, etc. The foregoing description is merely an example, and no limitation is imposed.

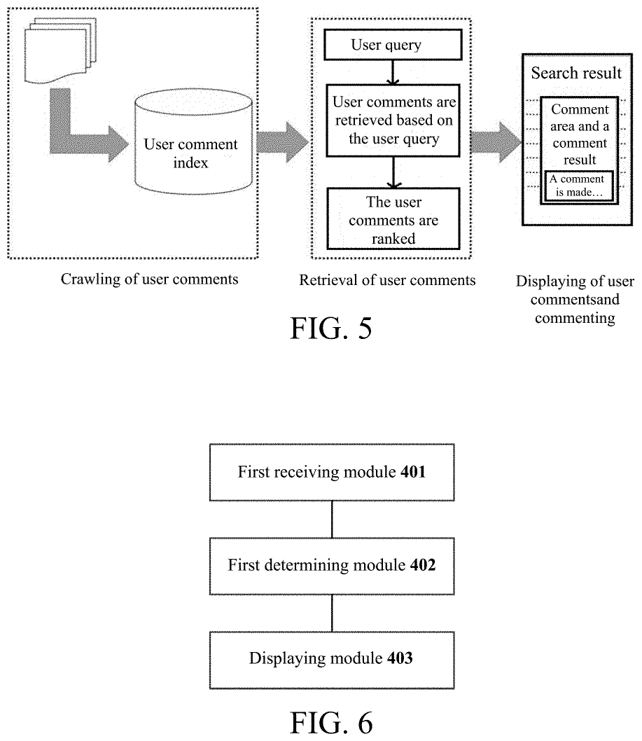

In one example, as shown in FIG. 5, during implementation of the solutions for displaying comment information, the server first crawls a webpage document in a related website of a network, and then captures a user's comment in the crawled webpage document, and builds a user comment index based on the captured user comment. On this basis, the server receives a user query input by a user through the front end of the search engine, and retrieves user comments in the user comment index according to the user query, and then ranks the retrieved user comments to determine a ranking result of the retrieved user comments, and then sends the ranked user comments to the front end of the search engine, and the front end of the search engine displays the received comment information in a comment area in the comment sub-page. In addition, the user can input the user's own comment information through a comment publishing box in the comment sub-page. The foregoing description is merely an example, and no limitation is imposed.

In the method for displaying comment information, the search request sent by the terminal device is received; the at least one piece of comment information associated with the search information carried in the search request is obtained, and the obtained at least one piece of comment information is integrated; and then the integrated comment information is transmitted to the terminal device; the search result information that is in response to the search request is received, where the search result information comprises the at least one piece of comment information associated with the search information carried in the search request, and then the comment integration information after a portion or all of the comment information is integrated is determined based on the search result information, and the comment integration information is displayed. The search information that is associated with the search information and that is input by the user can be integrated, helping the user to view the comment information associated with the search information, thereby reducing the time and cost spent by the user to view the comment information associated with the search information.

The method for displaying comment information may be performed by any suitable device having a data processing capability, including but not limited to: a camera, a terminal, a mobile terminal, a PC, a server, an in-vehicle device, an entertainment device, an advertising device, and a personal digital assistant (PDA), a tablet computer, a notebook computer, a handheld game console, smart glasses, a smart watch, a wearable device, a virtual display device, or a display enhancement device (such as Google Glass, Oculus Rift, Hololens, Gear VR), etc.

Referring to FIG. 6, a schematic structural diagram of a device for displaying comment information according to some embodiments is shown.

The device for displaying comment information includes: a first receiving module 401 configured to receive search result information that is in response to a search request, where the search result information comprises at least one piece of comment information associated with search information carried in the search request; a first determining module 402 configured to determine, based on the search result information, comment integration information after a portion or all of the comment information is integrated, and a displaying module 403 configured to display the comment integration information.

The device for displaying comment information is configured to implement the corresponding method for displaying comment information in the foregoing plurality of method embodiments, and has beneficial effects of the corresponding method embodiments. Details are not described herein again.

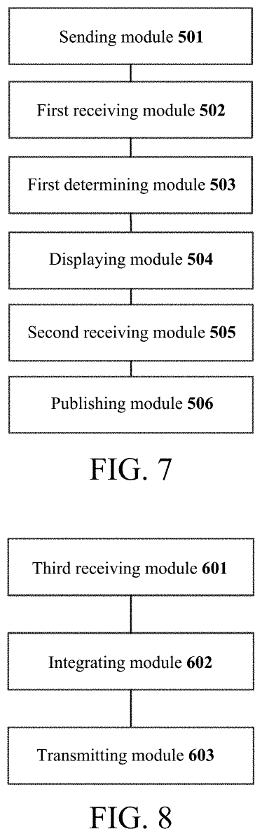

Referring to FIG. 7, a schematic structural diagram of a device for displaying comment information according to some embodiments is shown.

The device for displaying comment information includes: a first receiving module 502 configured to receive search result information that is in response to a search request, where the search result information comprises at least one piece of comment information associated with search information carried in the search request; a first determining module 503 configured to determine, based on the search result information, comment integration information after a portion or all of the comment information is integrated, and a displaying module 504 configured to display the comment integration information.

In some embodiments, the first determining module 503 is configured to: integrate, based on a preset integrated template, the portion or all of the comment information carried in the search result information to obtain the comment integration information; or obtain, from the search result information, the comment integration information after the portion or all of the comment information is integrated.

In some embodiments, the displaying module 504 is configured to: display the comment integration information in barrage form; or display the comment integration information using a floating window or a sliding window.

In some embodiments, after the displaying module 504, the device further includes: a second receiving module 505 configured to receive a publishing operation that is input by a user and that is based on the comment integration information; and a publishing module 506 configured to publish the comment information of the user based on the publishing operation.

In some embodiments, in addition to the first receiving module 502, the device further includes: a sending module 501 configured to send the search request to a server in response to an operation on a comment displaying control in a page, wherein the search result information is sent by the server.

In some embodiments, the comment information includes at least one of the following: identification information, a comment content, and a commenting time of a commenting user.

The device for displaying comment information is configured to implement the corresponding method for displaying comment information in the foregoing plurality of method embodiments, and has beneficial effects of the corresponding method embodiments. Details are not described herein again.

Referring to FIG. 8, a schematic structural diagram of a device for displaying comment information according to some embodiments is shown.

The device for displaying comment information includes: a third receiving module 601 configured to receive a search request from a terminal device; an integrating module 602 configured to: obtain at least one piece of comment information associated with search information carried in the search request, and integrate the obtained at least one piece of comment information; and a transmitting module 603 configured to transmit the integrated comment information to the terminal device.

The device for displaying comment information is configured to implement the corresponding method for displaying comment information in the foregoing plurality of method embodiments, and has beneficial effects of the corresponding method embodiments. Details are not described herein again.

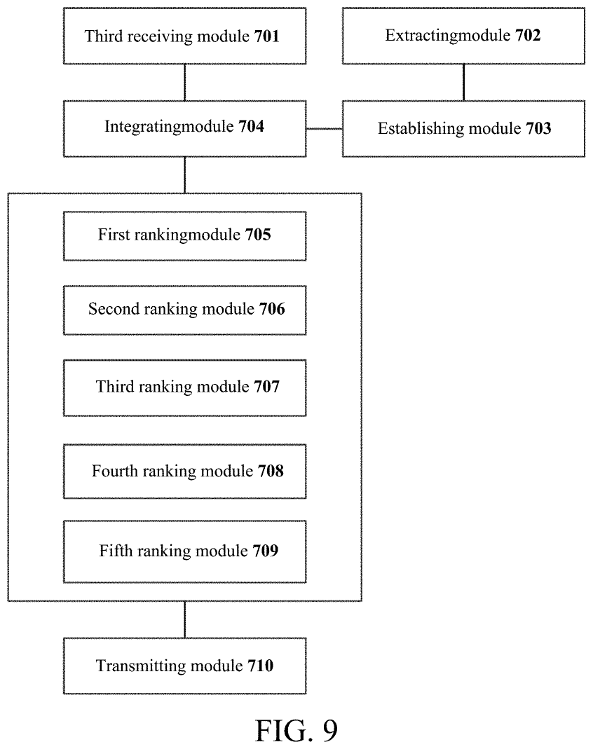

Referring to FIG. 9, a schematic structural diagram of a device for displaying comment information according to some embodiments is shown.

The device for displaying comment information includes: a third receiving module 701 configured to receive a search request from a terminal device; an integrating module 704 configured to: obtain at least one piece of comment information associated with search information carried in the search request, and integrate the obtained at least one piece of comment information; and a transmitting module 710 configured to transmit the integrated comment information to the terminal device.

In some embodiments, in addition to the integrating module 704, the device further includes: an extracting module 702 configured to: if a crawled webpage document comprises corresponding comment information, extract comment information in the webpage document; and an establishing module 703 configured to establish an index relationship between a title of the webpage document and the comment information in the webpage document.

In some embodiments, after the integrating module 704, the device further includes: a first ranking module 705 configured to: determine a similarity between the search information and the comment information, and rank the comment information based on the similarity between the search information and the comment information, to determine a ranking result of the comment information; or a second ranking module 706 configured to rank the comment information based on a number of messages that indicate a popular opinion and that are associated with the comment information, to determine a ranking result of the comment information; or a third ranking module 707 configured to rank the comment information based on an amount of content of the comment information, to determine a ranking result of the comment information; or a fourth ranking module 708 configured to rank the comment information based on a commenting time of the comment information, to determine a ranking result of the comment information; or a fifth ranking module 709 configured to: determine a similarity between the search information and the title of the webpage document to which the comment information belongs, and rank the comment information based on the similarity between the search information and the tile of the webpage document to which the comment information belongs, to determine a ranking result of the comment information.

In some embodiments, the first ranking module 705 is configured to: segment the content of the comment information, to determine segmented words of the comment information; generate, based on the segmented words of the comment information, a first vector representing the comment information; segment a content of the search information, to determine segmented words of the search information; generate, based on the segmented words of the search information, a second vector representing the comment information; and determine a similarity between the search information and the comment information based on the first vector and the second vector.

In some embodiments, the fifth ranking module 709 is configured to: segment the content of the search information, to determine segmented words of the search information; generate, based on the segmented words of the search information, a second vector representing the comment information; segment the title, to determine segmented words of the title; generate, based on the segmented words of the title, a third vector representing the comment information; and determine a similarity between the search information and the title of the webpage document to which the comment information belongs based on the second vector and the third vector.

In some embodiments, the fifth ranking module 704 is configured to: integrate the obtained at least one piece of comment information based on the ranking result of the comment information.

The device for displaying comment information is configured to implement the corresponding method for displaying comment information in the foregoing plurality of method embodiments, and has beneficial effects of the corresponding method embodiments. Details are not described herein again.

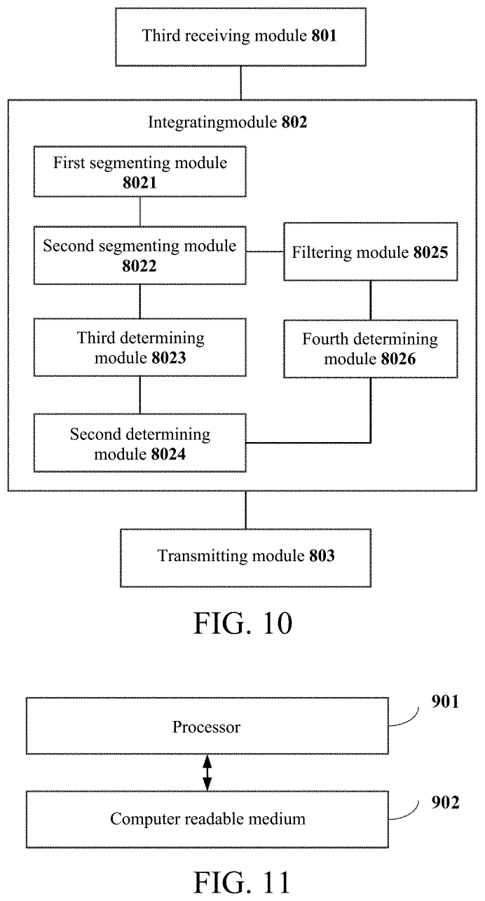

Referring to FIG. 10, a schematic structural diagram of a device for displaying comment information according to some embodiments is shown.

The device for displaying comment information includes: a third receiving module 801 configured to receive a search request from a terminal device; an integrating module 802 configured to: obtain at least one piece of comment information associated with search information carried in the search request, and integrate the obtained at least one piece of comment information; and a transmitting module 803 configured to transmit the integrated comment information to the terminal device.

In some embodiments, the integrating module 802 includes: a second determining module 8024 configured to: in response to determining that the search information matches the title of the webpage document, determine, based on the index relationship, that the comment information of the webpage document is the comment information associated with the search information carried in the search request.

In some embodiments, in addition to the second determining module 8024, the integrating module 802 further includes: a first segmenting module 8021 configured to segment the title of the webpage document, to determine segmented words of the title of the webpage document; a second segmenting module 8022 configured to segment a content of the search information, to determine segmented words of the search information; and a third determining module 8023 configured to: if the segmented words of the title of the webpage document include the segmented words of the search information, determine that the search information matches the title of the webpage document.

In some embodiments, after the second segmenting module 8022, the integrating module 802 further includes: a filtering module 8025 configured to perform stop word filtering on the segmented words of the search information to obtain filtered segmented words of the search information; a fourth determining module 8026 configured to: if the segmented words of the title of the webpage document include the filtered segmented words of the search information, determine that the search information matches the title of the webpage document.

The device for displaying comment information is configured to implement the corresponding method for displaying comment information in the foregoing plurality of method embodiments, and has beneficial effects of the corresponding method embodiments. Details are not described herein again.

FIG. 11 is a schematic structural diagram of an electronic device according to some embodiments. The electronic device may include: one or more processors 901; and a computer readable medium 902 configured to store one or more programs; when the one or more programs are executed by the one or more processors, the one or more processors implementing the method for displaying comment information according to the foregoing embodiments.

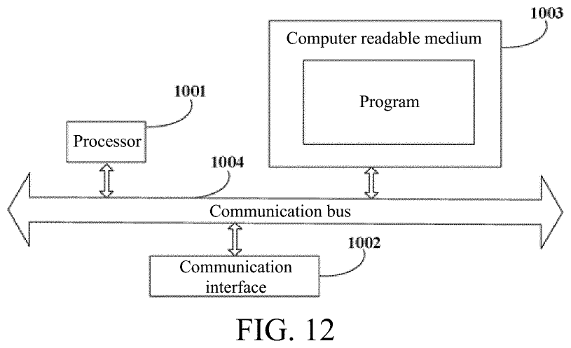

FIG. 12 is a hardware structure of an electronic device according to some embodiments. As shown in FIG. 12, the hardware structure of the electronic device may include a processor 1001, a communication interface 1002, a computer readable medium 1003, and a communication bus 1004.

Communication between the processor 1001, the communication interface 1002, and the computer readable medium 1003 is implemented through the communication bus 1004.

In some embodiments, the communication interface 1002 may be an interface of a communication module, for example, an interface of a GSM module.

The processor 1001 may be configured to: receive search result information that is in response to a search request, wherein the search result information comprises at least one piece of comment information associated with the search information carried in the search request; determine, based on the search result information, comment integration information after a portion or all of the comment information is integrated; and display the comment integration information. In addition, the processor 1001 may be further configured to: receive a search request from a terminal device; an integrating module configured to: obtain at least one piece of comment information associated with search information carried in the search request, and integrate the obtained at least one piece of comment information; and transmit the integrated comment information to the terminal device.

The processor 1001 may be a general-purpose processor, including a central processing unit (CPU), a network processor (NP), and the like, and may also be a digital signal processor (DSP), an application-specific integrated circuit (ASIC), a field programmable gate array (FPGA) or other programmable logical devices, discrete gate or transistor logical devices, and discrete hardware components. The processor 1301 may implement or perform the methods, the steps, and logical block diagrams that are disclosed in the embodiments of the present application. The general-purpose processor may be a microprocessor, or the processor may also be any conventional processor or the like.

The computer readable medium 1003 may be, but is not limited to, a random access memory (RAM), a read-only memory (ROM), a programmable read-only memory (PROM), an erasable programmable read-only memory (EPROM), an electrically erasable programmable read-only memory (EEPROM), or the like.

According to the embodiments of the present disclosure, the processes described above with reference to the flowcharts may be implemented as computer software programs. For example, an embodiment of the present disclosure includes a computer program product, and the computer program product includes a computer program stored in a computer readable medium. The computer program includes program code used for performing the methods shown in the flowcharts. In such an embodiment, by using a communication part, the computer program may be downloaded and installed from a network, and/or installed from a removable medium. When the computer program is executed by a CPU, the foregoing functions defined in the method of the present application are executed. The computer readable medium in the present application may be a computer readable signal medium or a computer readable storage medium or any combination thereof. The computer readable medium may be, for example, but not limited to, an electric, magnetic, optical, electromagnetic, infrared, or semi-conductive system, apparatus, or device, or any combination thereof. More examples of the computer readable storage medium may include but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a compact disk read-only memory (CD-ROM), an optical storage medium, a magnetic storage medium, or any appropriate combination thereof. In the present application, the computer readable storage medium may be any tangible medium including or storing a program, and the program may be used by or in combination with an instruction execution system, apparatus, or device. In the present application, the computer readable signal medium may include a data signal transmitted in a baseband or as part of a carrier, and stores computer readable program code. The propagated data signal may be in a plurality of forms, including, but not limited to, an electromagnetic signal, an optical signal, or any appropriate combination thereof. The computer readable signal medium may alternatively be any computer readable medium other than the computer readable storage medium. The computer readable medium may be configured to send, propagate, or transmit a program configured to be used by or in combination with an instruction execution system, apparatus, or device. The program code included in the computer readable medium may be transmitted by using any suitable medium, including but not limited to, via wireless transmission, a wire, a cable, radio frequency (RF) or the like, or any suitable combination of thereof.

The computer program code configured to execute the operations of the present application may be written by using one or more programming languages or a combination thereof. The programming languages include an object-oriented programming language such as Java, Smalltalk and C++, and also include a conventional procedural programming language such as “C” or similar programming languages. The program code may be completely executed on a user computer, partially executed on a user computer, executed as an independent software package, partially executed on a user computer and partially executed on a remote computer, or completely executed on a remote computer or server. For the case involving a remote computer, the remote computer may be connected to a user computer through any type of network including a local area network (LAN) or a wide area network (WAN), or may be connected to an external computer (for example, through the Internet by using an Internet service provider).

The flowcharts and block diagrams in the accompanying drawings show architectures, functions, and operations that may be implemented for the system, the method, and the computer program product according to the embodiments of the present application. In this regard, each box in a flowchart or a block diagram may represent a module, a program segment, or a part of code. The module, the program segment, or the part of code includes one or more executable instructions used for implementing specified logic functions. Although the steps are described in particular orders in the foregoing embodiments, the orders are merely exemplary. During implementations, some steps may be omitted, added, or performed in a different order. In some alternative implementations, functions shown in blocks may also be performed in an order different from that shown in the accompanying drawings. For example, two consecutive blocks may basically be performed simultaneously in fact, or sometimes may also be performed in a reverse order, depending on the related functions. Each block in the block diagram and/or the flowchart and a combination of the blocks in the block diagram and/or the flowchart may be implemented by using a dedicated hardware-based system that performs a specified function or operation, or may be implemented by using a combination of dedicated hardware and computer instructions.

The modules described in the embodiments of the present application may be implemented through software or hardware. The modules described may alternatively be disposed in a processor, for example, as in the following description: a processor including a first receiving module, a first determining module, and a displaying module. Names of the modules do not constitute a limitation on the modules in some cases. For example, the first receiving module may also be described as “a module configured to receive search result information that is in response to a search request.”

In some embodiments, the various modules of the devices or apparatuses shown in FIG. 6 to FIG. 10 may be implemented as software instructions or a combination of software and hardware. For example, the apparatus (or referred to as system) for displaying comment information described with reference to any of FIG. 6 to FIG. 10 may comprise one or more processors (e.g., a CPU) and one or more non-transitory computer-readable storage memories coupled to the one or more processors and configured with instructions executable by the one or more processors to cause one or more components (e.g., the one or more processors) of the system to perform various steps and methods of the modules described above (e.g., with reference to the method embodiments). In some embodiments, the apparatus for displaying comment information may include a server, a mobile phone, a tablet computer, a laptop computer, another computing device, or a combination of one or more of these computing devices.

According to another aspect, the present application further provides a computer readable medium on which a computer program is stored, and when executed by a processor, the program implements the method for displaying comment information according to the disclosed embodiments.

According to another aspect, the present application further provides a computer readable medium. The computer readable medium may be included in the apparatus described in the foregoing embodiments, or may exist alone and is not disposed in the apparatus. The computer readable medium store one or more programs, which, when executed by the apparatus, cause the apparatus to: receive search result information that is in response to a search request, wherein the search result information comprises at least one piece of comment information associated with the search information carried in the search request; determine, based on the search result information, comment integration information after a portion or all of the comment information is integrated; and display the comment integration information. In addition, the one or more programs further cause the apparatus to: receive a search request from a terminal device; an integrating module configured to: obtain at least one piece of comment information associated with search information carried in the search request, and integrate the obtained at least one piece of comment information; and transmit the integrated comment information to the terminal device.

The expressions “first,” “second,” “the first,” and “the second” used in the implementations of the present disclosure may define various components and do not imply any order and/or importance, but the expressions are not intended to limit the corresponding components. The foregoing expressions are merely used for distinguishing one element from another element. For example, the first user equipment and the second user equipment represent different user equipment, although the two are both user equipment. For example, the first element may be referred to as a second element, and similarly the second element may be referred to as a first element, without departing from the scope of the present disclosure.

When one element (for example, a first element) is described as “operably or communicatively connected” or “operably or communicatively connected to” or “connected to” another element (for example, a second element), the one element is connected to the other element directly or indirectly via another element (for example, a third element). Conversely, it may be understood that when an element (for example, a first element) is described as “directly connected” or “directly coupled” to another element (a second element), no intervening element (for example, a third element) exists between the two.

The foregoing descriptions are merely some embodiments of the present application and descriptions of the technical principles of the application. A person skilled in the art should understand that the scope of the present application is not limited to the technical solutions that are formed by the foregoing particular combinations of technical features, but shall also encompass other technical solutions formed by arbitrarily combining the foregoing technical features or equivalent features thereof without departing from the foregoing inventive concept. For example, technical solutions formed by replacing the foregoing features with technical features having similar functions disclosed in the present application (but not limited thereto) are also included.

What is claimed is:

1. A method for displaying comment information, wherein the method comprises:
receiving search result information that is in response to a search request, wherein the search result information comprises at least one piece of comment information associated with search information carried in the search request;
determining, based on the search result information, comment integration information after a portion or all of the comment information is integrated; and
displaying the comment integration information.

2. The method according to claim 1, wherein the determining, based on the search result information, comment integration information after a portion or all of the comment information is integrated comprises:
integrating, based on a preset integration template, the portion or all of the comment information carried in the search result information to obtain the comment integration information;
or
obtaining, from the search result information, the comment integration information after the portion or all of the comment information is integrated.

3. The method according to claim 1, wherein the displaying the comment integration information comprises:
displaying the comment integration information in a barrage form; or
displaying the comment integration information using a floating window or a sliding window.

4. The method according to claim 3, wherein after the displaying the comment integration information, the method further comprises:
receiving a publishing operation that is input by a user and that is based on the comment integration information; and
publishing comment information of the user based on the publishing operation.

5. The method according to claim 1, wherein before the receiving search result information that is in response to a search request, the method further comprises:
sending the search request to a server in response to an operation on a comment displaying control in a page, wherein the search result information is sent by the server.

6. The method according to claim 1, wherein the comment information comprises at least one of the following:
identification information, a comment content, and a commenting time of a commenting user.

7. A method for displaying comment information, wherein the method comprises:
receiving a search request from a terminal device;
obtaining at least one piece of comment information associated with search information carried in the search request, and integrating the obtained at least one piece of comment information; and
transmitting the integrated comment information to the terminal device.

8. The method according to claim 7, wherein before the obtaining at least one piece of comment information associated with search information carried in the search request, the method further comprises:
if a crawled webpage document comprises corresponding comment information, extracting the comment information in the webpage document; and
establishing an index relationship between a title of the webpage document and the comment information in the webpage document.

9. The method according to claim 8, wherein the obtaining at least one piece of comment information associated with search information carried in the search request comprises:
in response to determining that the search information matches the title of the webpage document, determining, based on the index relationship, that the comment information in the webpage document is the comment information associated with the search information carried in the search request.

10. The method according to claim 9, wherein before the determining, based on the index relationship, that the comment information in the webpage document is the comment information associated with the search information carried in the search request, the method further comprises:
segmenting the title of the webpage document to determine segmented words of the title of the webpage document;
segmenting a content of the search information to determine segmented words of the search information; and
if the segmented words of the title of the webpage document comprise the segmented words of the search information, determining that the search information matches the title of the webpage document.

11. The method according to claim 10, wherein after the segmenting a content of the search information to determine segmented words of the search information, the method further comprises:
performing stop word filtering on the segmented words of the search information to obtain filtered segmented words of the search information; and
if the segmented words of the title of the webpage document comprise the filtered segmented words of the search information, determining that the search information matches the title of the webpage document.

12. The method according to claim 7, wherein after the obtaining at least one piece of comment information associated with search information carried in the search request, the method further comprises:
determining a similarity between the search information and the comment information, and ranking the comment information based on the similarity between the search information and the comment information, to determine a ranking result of the comment information; or
ranking the comment information based on a number of messages that indicate a popular opinion and that are associated with the comment information, to determine the ranking result of the comment information; or
ranking the comment information based on an amount of content of the comment information, to determine the ranking result of the comment information; or
ranking the comment information based on a commenting time of the comment information, to determine the ranking result of the comment information; or
determining a similarity between the search information and the title of the webpage document to which the comment information belongs, and ranking the comment information based on the similarity between the search information and the title of the webpage document to which the comment information belongs, to determine the ranking result of the comment information.

13. The method according to claim 12, wherein the determining a similarity between the search information and the comment information comprises:
segmenting a content of the comment information to determine segmented words of the comment information;
generating, based on the segmented words of the comment information, a first vector representing the comment information;
segmenting a content of the search information to determine segmented words of the search information; and
generating, based on the segmented words of the search information, a second vector representing the search information; and
determining the similarity between the search information and the comment information based on the first vector and the second vector.

14. The method according to claim 12, wherein the determining a similarity between the search information and the title of the webpage document to which the comment information belongs comprises:
segmenting a content of the search information to determine segmented words of the search information;
generating, based on the segmented words of the search information, a second vector representing the search information;
segmenting the title to determine segmented words of the title;
generating, based on the segmented words of the title, a third vector representing the title; and
determining, based on the second vector and the third vector, the similarity between the search information and the title of the webpage document to which the comment information belongs.

15. The method according to claim 12, wherein the integrating the obtained at least one piece of comment information comprises:
integrating the obtained at least one piece of comment information based on the ranking result of the comment information.

16. A non-transitory computer-readable storage medium for displaying comment information, the storage medium configured with instructions executable by one or more processors to cause the one or more processors to perform operations comprising:
receiving search result information that is in response to a search request, wherein the search result information comprises at least one piece of comment information associated with search information carried in the search request;
determining, based on the search result information, comment integration information after a portion or all of the comment information is integrated; and
displaying the comment integration information.

17. The storage medium according to claim 16, wherein the determining, based on the search result information, comment integration information after a portion or all of the comment information is integrated comprises:
integrating, based on a preset integration template, the portion or all of the comment information carried in the search result information to obtain the comment integration information;
or
obtaining, from the search result information, the comment integration information after the portion or all of the comment information is integrated.

18. The storage medium according to claim 16, wherein the displaying the comment integration information comprises:
displaying the comment integration information in a barrage form; or
displaying the comment integration information using a floating window or a sliding window.

19. The storage medium according to claim 18, wherein after the displaying the comment integration information, the operations further comprise:
receiving a publishing operation that is input by a user and that is based on the comment integration information; and
publishing comment information of the user based on the publishing operation.

20. The storage medium according to claim 16, wherein before the receiving search result information that is in response to a search request, the operations further comprise:
sending the search request to a server in response to an operation on a comment displaying control in a page, wherein the search result information is sent by the server.
